(19) United States
(12) Patent Application Publication
(10) Pub. No.: US 2015/0106445 A1
(43) Pub. Date: Apr. 16, 2015

(54) METHOD FOR DISPLAYING A PUSH NOTIFICATION USING A DISPLAY DEVICE, AND THE DISPLAY DEVICE

(71) Applicant: Top Victory Investments Limited, Kowloon (HK)

(72) Inventors: Chuan-Ken Lin, New Taipei City (TW); Meng-Hsin Tsai, New Taipei City (TW)

(73) Assignee: TOP VICTORY INVESTMENTS LIMITED, Kowloon (HK)

(21) Appl. No.: 14/051,539

(22) Filed: Oct. 11, 2013

(51) Int. Cl. H04L 29/08

(52) U.S. Cl. CPC H04L 67/26
USPC 709/204

(57) ABSTRACT

In a method for displaying a notification, a display device receives a push notification associated with an application program through a communication network, and a visual media signal from an external computing device. The display device subsequently generates a to-be-displayed message based on the push notification, and a visual media based on the visual media signal. Then, the display device displays at least one of the visual media and the to-be-displayed message on a display screen of the display device. In cases that the display device is connected to the external computing device, the display device displays the visual media and the to-be-displayed message simultaneously on the display screen.

### BACKGROUND OF THE INVENTION

1. Field of the Invention

The invention relates to a method for displaying a push notification using a display device, and the display device.

2. Description of the Related Art

Recently developed display devices (e.g., a smart television (TV)) have become widely available. Various capabilities, such as running an operating system (OS), application programs, Internet connection, etc., have been integrated into the now commercially available smart TV.

Generally, a conventional display device includes a computer host (which may be embedded) that operates an OS therein, and may include other interfaces (e.g., composite video connector sockets, High-Definition Multimedia Interface (HDMI), etc.) for coupling to other external signal sources for receiving signals therefrom. As a result, a display screen of the conventional display device is not only able to display internal signals from the computer host, and is also able to display external signals from other external signal sources when coupled thereto. In such cases, the conventional display device may be provided with a switch function for a user to switch between different signal sources.

However, for the conventional display device, when the display screen is controlled to display external signals from the external signal sources, the internal signals from the embedded computer host will be unavailable to the user viewing the display screen. For example, when a push notification (i.e., a notification sent to signal updates from services such as email, news feed, instant message (IM) applications, social networking service updates, etc.) is sent to the computer host via the Internet, the user will be able to see the content of the push notification on the display screen only when the internal signals from the embedded computer host are being displayed. Therefore, when the user desires to be updated with the push notification immediately after the push notification while viewing the external signals, the user may need to switch between the internal signals and the external signals frequently.

### SUMMARY OF THE INVENTION

Therefore, the object of the present invention is to provide a method that can be implemented on a display device so as to address at least some of the drawbacks found in the conventional display device.

Accordingly, a method of the present invention is for displaying a notification, and is to be implemented using a display device. The display device is coupled to a communication network and includes an operating system (OS) module operating an OS which supports an application program, a display control module coupled to the OS module and coupled to an external computing device for receiving a visual media signal therefrom, and a display screen coupled to the display control module. The method comprises:

(a) receiving, by the OS module, a push notification associated with the application program through the communication network;

(b) by the OS module, generating notification data based on the push notification, and transmitting the notification data to the display control module;

(c) generating, by the display control module, a to-be-displayed message based on the notification data, and a visual media based on the visual media signal; and

(d) when the display device is connected to the external computing device, controlling, by the display control module, the display screen to display the visual media and the to-be-displayed message simultaneously.

Another object of the present invention is to provide the display device that implements the abovementioned method.

Accordingly, a display device of the present invention is to be coupled to a communication network and to be connected to an external computing device for receiving a visual media signal therefrom. The display device comprises an operating system (OS) module, a display control module and a display screen.

The OS module operates an OS. The OS supports an application program. The OS module is configured to receive a push notification associated with the application program through the communication network, and is operable to generate notification data based on the push notification.

The display control module is coupled to the OS module for receiving the notification data therefrom. The display control module is configured to receive the visual media signal from the external computing device, and is operable to generate a to-be-displayed message based on the notification data. The display control module is further operable to generate a visual media based on the visual media signal.

The display screen is coupled to the display control module. When the display device is coupled to the external computing device, the display control module is operable to control the display screen to display the visual media and the to-be-displayed message simultaneously.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of a preferred embodiment of a display device according to the invention;

FIG. 2 is a flow chart of a method for displaying a push notification on the display device, according to the preferred embodiment;

FIG. 3 is a flow chart of a method for displaying the push notification on the display device, according to a modification of the preferred embodiment; and

FIG. 4 illustrates a name of an application program being displayed on a display screen of the display device according to the preferred embodiment.

### DETAILED DESCRIPTION OF THE PREFERRED EMBODIMENT

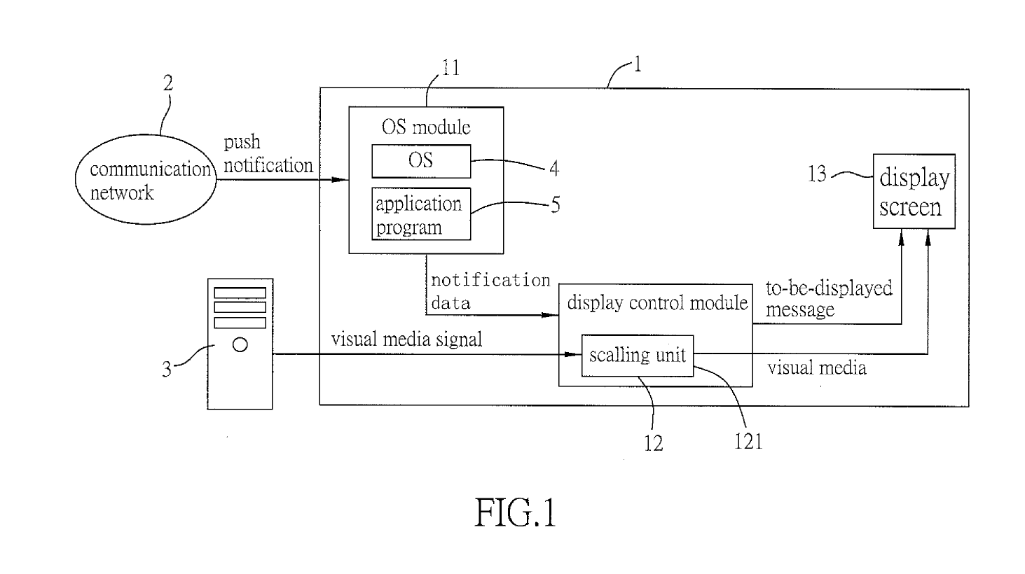

As shown in FIG. 1, the preferred embodiment of a display device 1 according to the present invention comprises an operating system (OS) module 11, a display control module 12, and a display screen 13. The display device 1 is configured to be coupled to a communication network 2 (e.g., Internet, telecommunication networks, etc.), and is configured to be optionally electrically connected to an external computing device 3, which may serve as an external signal source, for receiving a visual media signal therefrom.

The OS module 11 may be embodied within the display device 1 for operating an OS 4. In this embodiment, the OS 4 is Android system, and therefore the display device 1 is enabled to be operated as an Android device. The OS 4 supports execution of at least one application program 5 (such as an instant message (IM) application). The OS module 11 is configured to receive a push notification associated with the application program 5 through the communication network 2. Upon receipt of the push notification, the OS module 11 is operable to generate notification data based on the push notification. The notification data may be in the form of a string of alphanumeric characters.

The display control module 12 is coupled to the OS module 11 for receiving the notification data therefrom. The display control module 12 includes a scaling unit 121 that is configured to receive the visual media signal from the external computing device 3, and to process the visual media signal so as to generate a visual media based on the visual media signal. Specifically, the scaling unit 121 is able to rescale the received signals that are to be eventually displayed on the display screen 13.

In addition, the display control module 12 is configured to generate a to-be-displayed message based on the notification data. In this embodiment, the to-be-displayed message may be converted into the form of an image that can be processed by the scaling unit 121.

The display screen 13 is coupled to the display control module 12 for receiving the visual media and the to-be-displayed message therefrom. The display device 1 may be provided with a mode-setting interface (not depicted in the drawings) that enables a user to select from different displaying modes of the display control module 12.

For example, in this embodiment, the display control module 12 may be operable in one of a normal mode and an on-screen display (OSD) mode. In the normal mode, the display control module 12 is operable to control the display screen 13 to display one of the visual media and signals from the OS 4, depending on whether the display device 1 is electrically connected to the external computing device 3, and further on preference of the user given that the display device 1 is coupled to the external computing device 3.

On the other hand, in the OSD mode, the display control module 12 is operable to control the display screen 13 to display the visual media and the to-be-displayed message simultaneously. For example, both the visual media and the to-be-displayed message may be displayed on the display screen 13 by way of superimposing the to-be-displayed message over apart of the visual media.

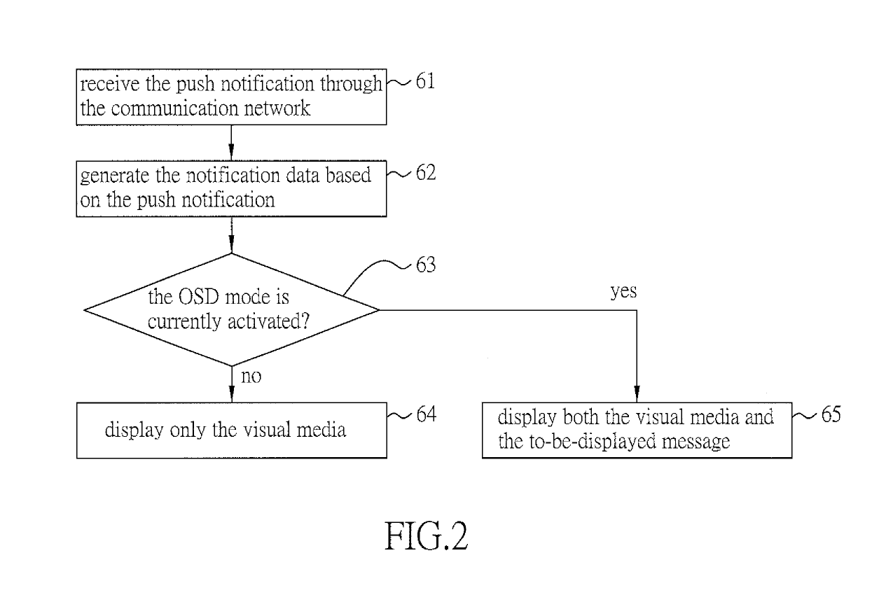

Steps of a method for displaying the push notification on the display device 1 will now be described in detail with reference to FIG. 2.

In step 61, the OS module 11 receives the push notification through the communication network 2. In this embodiment, this step may be executed through Android cloud to device messaging (C2DM) service.

In step 62, the OS module 11 generates the notification data based on the push notification received in step 61, and transmits the notification data to the display control module 12 for subsequent processing. In this embodiment, the content of the notification data may include a name and/or logo of the associated application program 5.

Afterward, in step 63, the display control module 12 generates the to-be-displayed message based on the notification data, and determines whether the normal mode or the OSD mode is currently activated. When it is determined that the normal mode is activated, the flow proceeds to step 64, in which the display control module 12 controls the display screen 13 to display only the visual media thereon (in this way, the user will not be notified by the display screen 13).

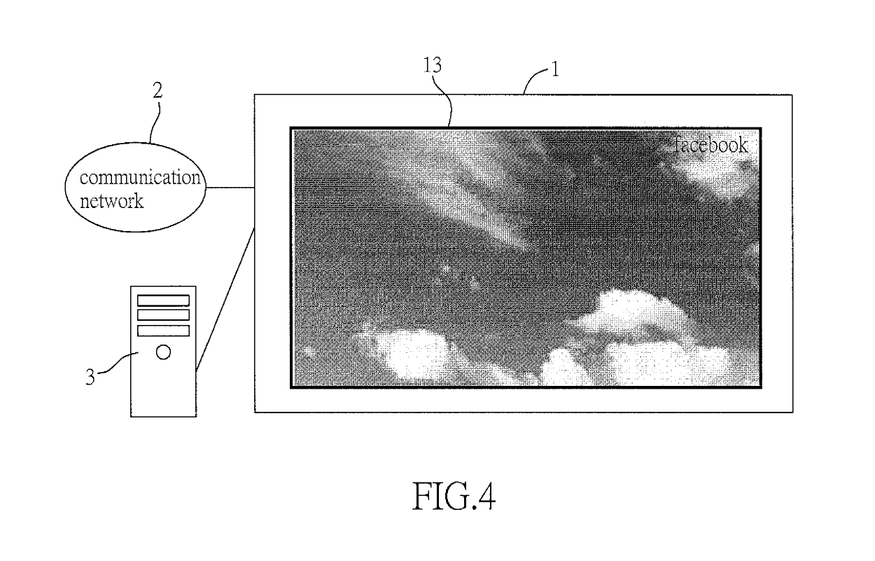

On the other hand, when it is determined that the OSD mode is activated, the flow proceeds to step 65, in which the display control module 12 controls the display screen 13 to display simultaneously both the visual media and the to-be-displayed message on the display screen 13 by superimposing the to-be-displayed message over a part of the visual media. It is worth noting that, in some examples, the user may only select the name/logo of the application program 5, instead of the entire to-be-displayed message, to be displayed on the display screen 13 in order to minimize the area of the display screen 13 occupied by the to-be-displayed message. The resulting image may be such as that illustrated in FIG. 4, in which the name of the application program 5 (e.g., facebook®) is shown on the upper right corner of the display screen 13.

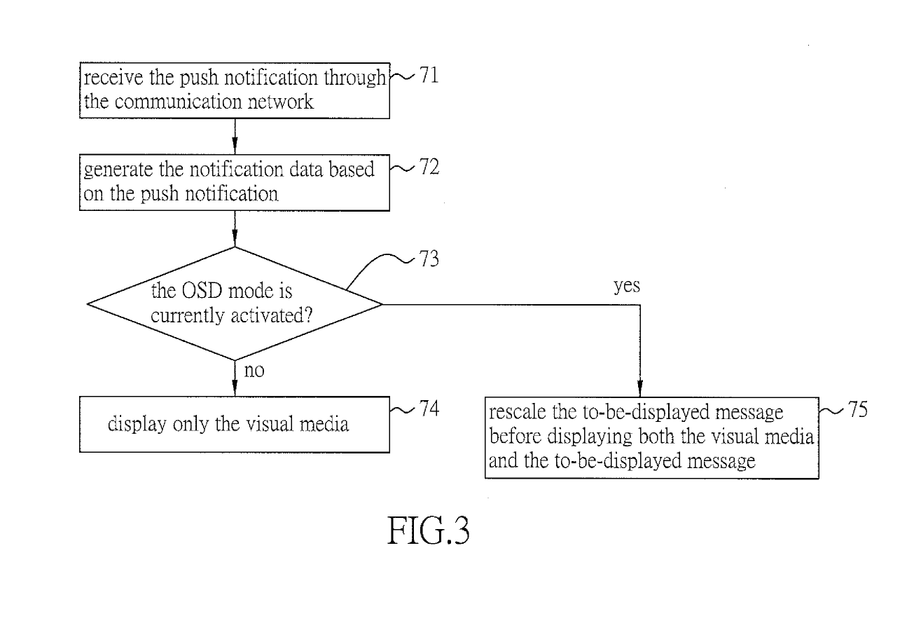

FIG. 3 illustrates a modification of the method depicted in FIG. 2. In this modification, steps 71, 72, 73 and 74 are executed by the display device 1 in a manner similar to that described in steps 61, 62, 63 and 64, respectively. For the sake of brevity, details regarding these steps will not be repeated herein.

In step 75, the scaling unit 121 is operable to rescale the to-be-displayed message before the display control module 12 controls the display screen 13 to display the same. The resealing may be based on a predetermined setting inputted by the user. By inputting the predetermined setting, the user may adjust an exact location of the to-be-displayed message that is to be displayed, as well as a size of the to-be-displayed message.

To sum up, the method and the display device 1 of the present invention employs the on-screen display technique to enable the to-be-displayed message associated with the push notification to be displayed on the display screen 13 even when the display device 1 is currently displaying the visual media from the connected external computing device 3. As a result, the user will be promptly notified by the push notification without having to switch between the signals to be displayed by the display screen 13.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A display device to be coupled to a communication network and to be coupled to an external computing device for receiving a visual media signal therefrom, said display device comprising:
an operating system (OS) module that operates an OS which supports an application program, that is configured to receive a push notification associated with the application program through the communication network, and that is operable to generate notification data based on the push notification;
a display control module coupled to said OS module for receiving the notification data therefrom, said display control module being configured to receive the visual media signal from the external computing device and operable to generate a to-be-displayed message based on the notification data, and a visual media based on the visual media signal; and
a display screen coupled to said display control module;
wherein when said display device is coupled to the external computing device, said display control module is operable to control said display screen to display the visual media and the to-be-displayed message simultaneously.

2. The display device of claim 1, wherein:
said display control module is operable in one of a normal mode and an on-screen display (OSD) mode;
in the normal mode, said display control module controls said display screen to display only the visual media; and
in the OSD mode, said display control module controls said display screen to display both the visual media and the to-be-displayed message by superimposing the to-be-displayed message over a part of the visual media.

3. The display device of claim 1, wherein said display control module generates the to-be-displayed message in the form of an image that contains content of the push notification.

4. The display device of claim 3, wherein said display control module includes a scaling unit that is configured to rescale at least one of the visual media and the to-be-displayed message before displaying the same on said display screen.

5. The display device of claim 3, wherein the notification data includes at least one of a name and a logo of the application program.

6. The display device of claim 1, wherein the OS is Android system.

7. The display device of claim 6, wherein said OS module is configured to receive the push notification using Android Cloud to Device Messaging (C2DM) service.

8. A method for displaying a push notification, which is to be implemented using a display device that is coupled to a communication network and that includes an operating system (OS) module operating an OS which supports an application program, a display control module coupled to the OS module and coupled to an external computing device for receiving a visual media signal therefrom, and a display screen coupled to the display control module, said method comprising:
(a) receiving, by the OS module, a push notification associated with the application program through the communication network;
(b) by the OS module, generating notification data based on the push notification, and transmitting the notification data to the display control module;
(c) generating, by the display control module, a to-be-displayed message based on the notification data, and a visual media based on the visual media signal; and
(d) controlling, by the display control module, the display screen to display at least one of the visual media and the to-be-displayed message.

9. The method of claim 8, wherein step (d) includes the following sub-steps of:
(d1) in a normal mode, controlling, by the display control module, the display screen to display only the visual media on the display screen; and
(d2) in an on-screen display mode, controlling, by the display control module, the display screen to display both the visual media and the to-be-displayed message by superimposing the to-be-displayed message over apart of the visual media.

10. The method of claim 8, wherein, in step (c), the to-be-displayed message is generated in the form of an image that contains content of the push notification.

11. The method of claim 10, wherein, in step (c), at least one of the visual media and the to-be-displayed message is rescaled before being displayed.

12. The method of claim 10, wherein the notification data includes at least one of a name and a logo of the application program.

13. The method of claim 8, wherein the OS is Android system.

14. The method of claim 13, wherein, in step (a), the OS module receives the push notification through Android Cloud to Device Messaging (C2DM) service.
